(19) United States
(12) Patent Application Publication
(10) Pub. No.: US 2002/0188431 A1
(43) Pub. Date: Dec. 12, 2002

(54) Method of determining by numerical simulation the restoration conditions, by the fluids of a reservoir, of a complex well damaged by drilling operations

(76) Inventors: Yu Didier Ding, Chatou (FR); Daniel Longeron, Sartrouville (FR); Gerard Renard, Rueil Malmaison (FR); Hayet Annie Audibert, Croissy Sur Seine (FR)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/139,242

(22) Filed: May 7, 2002

(30) Foreign Application Priority Data
May 9, 2001 (FR) 01/06.216
Jun. 12, 2001 (FR) 01/07.764

(51) Int. Cl. G06G 7/48

(52) U.S. Cl. 703/10

(57) ABSTRACT

Method of determining by numerical simulation the optimum conditions to be applied in a horizontal (or complex) well drilled through an underground reservoir so as to progressively eliminate (restore), by the fluids from the reservoir, deposits or cakes formed in at least a peripheral zone of the well as a result of drilling and completion operations.

The method essentially comprises acquiring initial data obtained by laboratory measurements of the values, according to the initial permeability (ki) of the formations surrounding the well, of the thickness of the cakes and of the damaged permeability (kd) and restored permeability (kf) values of this zone, as a function of the distance (r) to the wall of the well, discretizing the damaged zone by means of a 3D cylindrical grid pattern forming blocks of small radial thickness in relation to the diameter of the well, and solving in this grid pattern the diffusivity equation modelling the flow of the fluids through the cakes by taking account of the measured initial data and by modelling the evolution of the permeability as a function of the flow rates (Q) of fluids flowing through the cakes, so as to deduce therefrom the optimum conditions to be applied for producing the well.

Application: production of hydrocarbon reservoirs for example under deep offshore conditions in weakly consolidated formations (Gulf of Mexico, Angola, etc.).

### FIELD OF THE INVENTION

The present invention relates to a method of determining by numerical simulation the optimum conditions to be applied in a horizontal (or complex) well drilled through an underground reservoir, so as to progressively eliminate (restore), by flushing by means of the production fluids from the reservoir, deposits or cakes formed in at least a peripheral zone of the well, as a result of drilling and completion operations.

It is well-known to the man skilled in the art to distinguish between the cakes referred to as internal cakes, formed by mud invasion of the rock pores, and the cakes referred to as external cakes, consisting of a mud coat on the external wall of the well.

### BACKGROUND OF THE INVENTION

The damage caused to the formations surrounding horizontal (or complex) wells, often open holes equipped for production, constitutes a critical point for deep offshore oil fields where only a limited number of very productive wells is produced so as to obtain acceptable development costs.

The tests that can be carried out to characterize formation damage in the vicinity of a well are of primordial importance. They allow to select the most suitable drilling fluid to minimize or reduce permeability deterioration in the vicinity of the wells and to optimize the well cleaning techniques.

During the past five years, the claimant has developed a specific laboratory test equipment and procedures intended to characterize formation damage due to drilling during operations under overpressure conditions and to quantify the performances of the various cleaning techniques used in the industry, as shown in the following publications:

Alfenore, J. et al., <<What Really Matters in our Quest of Minimizing Formation Damage in Open Hole Horizontal Wells >>, 1999, SPE 54731,

Longeron, D. et al., <<Experimental Approach to Characterize Drilling Mud Invasion, Formation Damage and Cleanup Efficiency in Horizontal Wells with Openhole Completions >>, 2000, SPE 58737, or

Longeron, D. et al., <<An Integrated Experimental Approach for Evaluating Formation Damage due to Drilling and Completion Fluids >>, 1995, SPE 30089.

However, the surveys carried out in the laboratory are often insufficient by themselves to realistically model the production conditions to be applied in wells so as to best restore the permeability of the surrounding formations without causing sand encroachment. Modelling the procedures for restoring formations surrounding a well is of great economic interest for the production of oil fields.

### SUMMARY OF THE INVENTION

The method according to the invention allows to best simulate the optimum conditions to be applied in a well drilled through an underground reservoir with any trajectory, so as to progressively eliminate, by means of the reservoir fluids, deposits or cakes formed in at least a peripheral zone of the well as a result of drilling operations.

It comprises acquiring initial data obtained by laboratory measurements of the initial permeability values (ki) of the formations surrounding the well, the thickness of the cakes and the damaged permeability (kd) and restored permeability (kf) values of this zone, as a function of the distance (r) to the wall of the well, discretizing the damaged zone by means of a 3D cylindrical grid pattern forming blocks of small radial thickness in relation to the diameter of the well, and solving in this grid pattern diffusivity equations modelling the flow of the fluids through the cakes by taking account of the measured initial data and by modelling the evolution of the permeability as a function of the flow rates (Q) of fluids flowing through the cakes, so as to deduce therefrom the optimum conditions to be applied for producing the well.

Permeability restoration is modelled at any point at a distance (r) from the wall by considering for example that the permeability varies proportionally to the difference between the damaged permeability (kd) and the restored permeability (kf), the proportionality coefficient depending on an empirical law of permeability variation as a function of the quantity of fluids through the cakes.

The simulation performed according to the method allows reservoir engineers to better predict the best development scheme for the reservoir while avoiding drawbacks such as sand encroachment. It also allows drillers to select fluids more particularly suited for well drilling and equipment setting, considering the known or estimated permeability data.

### BRIEF DESCRIPTION OF THE DRAWINGS

Other features and advantages of the method and of the device according to the invention will be clear from reading the description hereafter of a non limitative example, with reference to the accompanying drawings wherein:

FIG. 1 shows the curves of variation, as a function of the distance r to the wall of the damaged well, of a first multiplying coefficient c₁(r) of the damaged permeability and of a second multiplying coefficient c₂(r) of the restored permeability,

FIG. 2 shows an empirical law of variation of a variation coefficient of the permeability at a distance r from the wall of the damaged well, as a function of the fluid flow rate Qₛ through the cakes,

FIG. 3 shows an example of a radial grid pattern for solving the diffusivity equations,

FIG. 4 illustrates the calculation of flow F with a radial grid pattern,

FIGS. 5a and 5b illustrate the calculation of the numerical productivity index IP without an external cake and with an external cake Cext respectively, through a grid cell Wcell,

FIG. 6 diagrammatically shows a well portion of length L and of radius rw comprising 4 zones of depth r centered around the well, with different permeabilities k, 100 mD or 1000 mD, and an internal cake of thickness rᵢₙₜ.

FIGS. 7, 8 show the variations, as a function of the distance d to the well, of the multiplying coefficients respectively of damaged permeability c₁(r) and of restored permeability c₂(r), which were measured in the laboratory in different zones and used in the examples,

FIG. 9 shows the curve of permeability variation c(r) in the internal cake as a function of the cumulative volume q of fluid per surface unit available for flow, measured in the laboratory and used in the examples,

FIGS. 10a to 10c respectively show the variations, as a function of time t(d) expressed in days, of the oil flow rates FR (in m³/d) in various perforated zones along the well, corresponding to 3 different simulations SM1 to SM3, in example 1 (case a),

FIGS. 11a and 11b show the variations, as a function of time t(d) expressed in days, of the permeability coefficient c(r) of the internal cake in two different zones along the well (example 1),

FIG. 12 shows the variation, as a function of time, of the total flow rate FR (m³/d) in the case c of example 1, for three different simulations SM1 to SM3,

FIG. 13 shows the distribution of the external cake along the well portion, in example 2,

FIGS. 14a to 14c respectively show in example 2 the distribution, over length L(m) of the well, of the external cake (FIG. 14a) and of flow rate FR along the well at the time t=0.5 d (FIG. 14b) and at the time t=5 d (FIG. 14c),

FIGS. 15a to 15f respectively show in example 2 the distribution, over length L(m) of the well, of the external cake (FIG. 15a) and of flow rate FR along the well, respectively at the time t=0.1 d (FIG. 15b), t=0.3 d (FIG. 15c), t=0.5 d (FIG. 15d), time t=1 d (FIG. 15e) and t=5 d (FIG. 15f),

FIG. 16 shows the total flow rate FR of the well as a function of the time expressed in days, in example 2, for cases c1 and c2,

FIG. 17 is a chart showing an example of gridding with NX grid cells distributed along the well, progressively thicker as they are radially further from the wall of the well (direction r(m)), and

FIG. 18 is a chart showing the application time t(d), expressed in days, of an imposed bottomhole pressure P(bar).

### DETAILED DESCRIPTION

I—Laboratory Data Acquisition

Formation damage tests are of primordial importance for minimizing or reducing the permeability deterioration in the vicinity of wells by selecting the most suitable drilling fluid and by optimizing the well cleaning techniques. During the past five years, the claimant has developed a specific laboratory test equipment and procedures intended to characterize the formation damage due to drilling during operations under overpressure conditions and to quantify the performances of the various cleaning techniques used in the industry, as shown in the following publications:

Alfenore, J. et al., <<What Really Matters in our Quest of Minimizing Formation Damage in Open Hole Horizontal Wells >>, 1999, SPE 54731,

Longeron, D. et al., <<Experimental Approach to Characterize Drilling Mud Invasion, Formation Damage and Cleanup Efficiency in Horizontal Wells with Openhole Completions >>, 2000, SPE 58737, or

Longeron, D. et al., <<An Integrated Experimental Approach for Evaluating Formation Damage due to Drilling and Completion Fluids >>, 1995, SPE 30089.

The leak-off pressure tests are carried out with a dynamic filtration cell which can receive 5-cm diameter cores whose length can reach 40 cm. The cell is for example equipped with five pressure taps arranged 5, 10, 15, 20 and 25 cm away from the inlet face of the core. The pressure taps allow to monitor the pressure drops through six sections of the core while mud is circulated and oil is circulated back in order to simulate production. In order to reproduce the dynamic process of mud and mud filtrate invasion, the laboratory tests are carried out under representative well conditions (temperature, overpressure and shear rate applied to the mud, cores saturated with oil and connate water, etc.). Oil is then injected in the opposite direction (backflow) at constant flow rate so as to simulate well production. The evolution of the restored permeabilities is calculated, for each section, as a function of the cumulative volume of oil injected. The final stabilized value of the restored permeability is then compared with the initial non deteriorated permeability in order to evaluate the residual deterioration as a function of the distance to the inlet face of the core. It has generally been observed that a total amount of 10 to 20 PV (a hundred PV at most) of injected oil was enough to obtain a stabilized value for the restored permeability after damage with an oil-base mud.

II—Simplified Numerical Model for Suppressing the Damage in the Vicinity of the Well

Considering a well drilled in the oil zone with an oil-base mud, the properties of the oil in the reservoir are assumed to be identical to those observed in the filtrate. The equation of flow in the vicinity of the well is thus governed by a single-phase equation expressed as follows:

$$- div ( \frac{k}{μ} ∇ p ) = c φ \frac{\partial p}{\partial t} \qquad ( 1 )$$

where p is the pressure, k the absolute permeability, μ the viscosity, c the compressibility and φ the porosity. The viscosity μ and the compressibility c in the filtrate are considered to be similar to those observed in the oil that saturates the reservoir. The initial pressure in the reservoir is considered to be hydrostatic at production start.

II-1 Modelling the Internal Filter Cake

The internal filter cake reduces the permeability of the reservoir in the vicinity of the well. As mentioned above, the permeability reductions after the drilling period and at the end of a complete cleaning operation can be obtained from laboratory measurements. For modelling, we use the permeability reduction factor in dimensionless form to represent the permeability variation. Using the dimensionless forms affords the advantage of allowing the data to be grouped together by geologic zones.

Let kᵢ be the initial permeability, k_{d} the damage permeability and kf the final restored permeability; the damage permeability and the final restored permeability generally depend on r the distance to the well.

$${c}_{1} ( r ) = \frac{{k}_{d} ( r )}{{k}_{i}} and {c}_{2} ( r ) = \frac{{k}_{f} ( r )}{{k}_{i}}$$

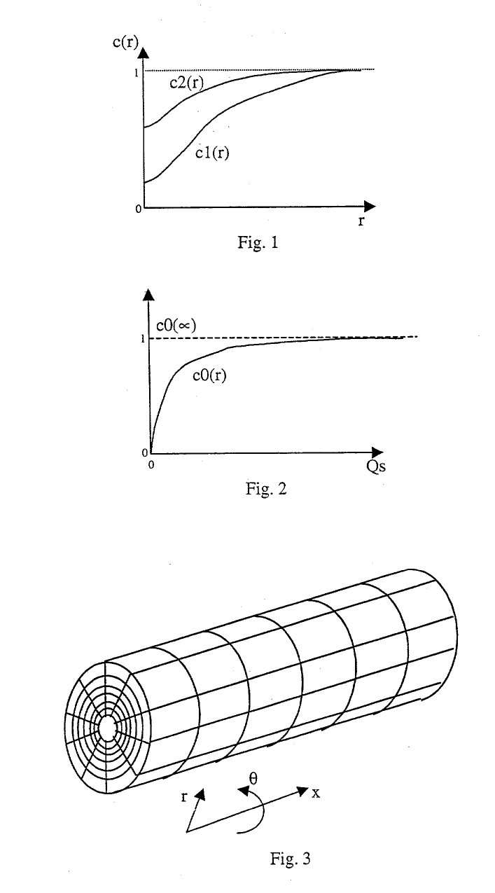

being the curves of the permeability reduction factor as a function of r before cleaning and after the fluid backflow respectively (FIG. 1), the permeability variation in the vicinity of the well is generally limited by these two curves during the fluid backflow period. c₁(r) corresponds to the damage permeability curve and c₂(r) to the stabilized restored permeability curve.

As mentioned above, the permeability variation in the zone occupied by the internal filter cake during the fluid backflow period depends on the amount of oil produced flowing towards the well. We use the dimensionless form as follows to describe this variation (FIG. 2):

$${c}_{0} ( Q ) = \frac{k ( Q ) - {k}_{d}}{{k}_{f} - {k}_{d}} \qquad ( 2 )$$

where Q is the total rate of flow through the porous medium in the direction of the flow divided by the porous surface (pore surface available for the flow). This curve represents the permeability variation in relation to the flow through a porous surface unit. It generally corresponds to a given direction of flow. In practice, the direction of flow is the radial direction towards the well. When Q=0, there is no flow allowing to clean the filter cake, the permeability corresponds to the damage permeability with k(0)=k_{d}. When Q is very great, the filter cake is entirely cleaned, the permeability corresponds to the final restored permeability with k(+∞)=k_{f}. In this case, we have c₀(+∞)=1.

The permeability variation curve can be measured from laboratory data and it can be considered to be independent of the location in a core. Thus, a curve is used for each geologic zone. This curve is monotonic. Its maximum is generally reached for several m³ (or several ten m³) of fluid crossed per porous surface unit.

Permeability k at the distance r from the well during the fluid backflow period can be written in the following trivial form:

$$k ( r , Q ) = ( {k}_{f} ( r ) - {k}_{d} ( r ) ) \frac{{k}_{r} ( r , Q ) - {k}_{d} ( r )}{{k}_{f} ( r ) - {k}_{d} ( r )} + {k}_{d} ( r ) \qquad ( 3 )$$

By using the dimensionless curves defined above and by taking account of Equation (2), permeability reduction factor c(r,Q) is expressed by:

c(r,Q)=(c₂(r)−c₁(r))c₀(Q)+c₁(r) (4)

Initially, Q=0, the permeability reduction corresponds to the reduction obtained after filtrate invasion (damage permeability):

c(r,0)=c₁(r) (5)

After the fluid backflow, when the amount of flowing fluid Q is very large with c₀(Q)≈1, the permeability reduction corresponds to the restored state with the stabilized restored permeability:

c(r,Q)=c₂(r) (6)

The permeability variation in the zone occupied by the internal filter cake is modelled with Equation (3). Unlike the internal filter cake, the effect of the external filter cake described hereafter is modelled in the form of a skin factor in the discretized numerical model.

II-2 Grid Pattern and Numerical Schemes

A cylindrical grid pattern rθx is used for modelling the fluid flow in the vicinity of a horizontal well (FIG. 3): r is the radial direction, perpendicular to the axis of the well, θ is the angular direction and x is the direction along the well. With this grid pattern, the boundaries of the well are discretized and very small grid cells can be used to discretize the zone occupied by the internal filter cake. In general, the radius of the well is of the order of some centimeters, and the thickness of the internal filter cake ranges between some centimeters and some decimeters. In order to obtain a good description of the filter cake elimination phenomenon, the grid cells used in the vicinity of the well range between some millimeters and some centimeters.

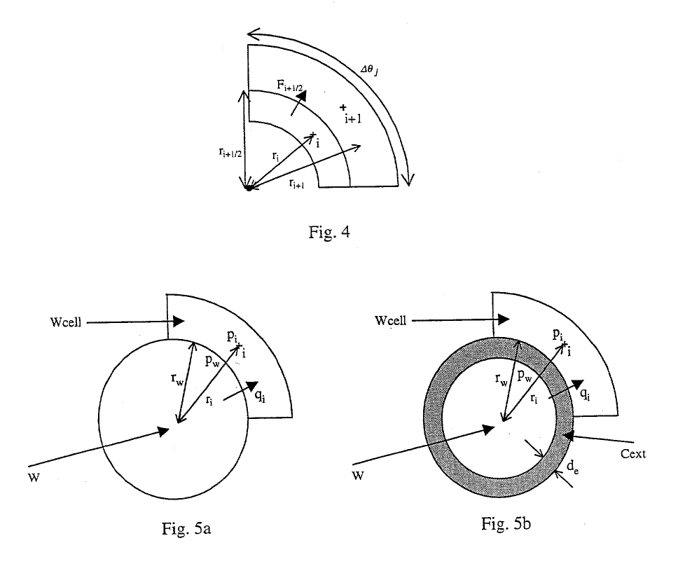

For cylindrical grid cells, a numerical standard scheme for approximation of the flow between two points can be used to model the flow. For example, the flow between two neighbouring grid cells i and i+1 in the radial direction is calculated by (FIG. 4):

F_{i+1/2}=T_{i+1/2}(pᵢ₊₁−pᵢ) (7)

$$with : {T}_{i + 1 / 2} = \frac{1}{\frac{1}{{k}_{r , i}} ln \frac{{r}_{i + 1 / 2}}{{r}_{i}} + \frac{1}{{k}_{r , i + 1}} ln \frac{{r}_{i + 1}}{{r}_{i + 1 / 2}}} Δ {θ}_{j} Δ {x}_{k} \qquad ( 8 )$$

where j and k are the indices of the grid cells considered in directions θ and r, rᵢ is the distance from grid cell i to the well, r_{i+1/2} is the distance from the interface of the grid cells considered to the well, k_{r,i} is the permeability of grid cell i in the radial direction, Δ and Δ× are the lengths of the grid cells in directions θ and x, and Tᵢ is the transmissivity between grid cells.

The term <<well grid cells >>referring to the grid cells that discretize the well boundaries, the well boundary conditions are dealt with in the well grid cells. The internal pressure p_{w} of the well and the flow rate qᵢ of the well on a given grid cell i can be related by the following discretization formula (FIG. 5a):

qᵢ=IPᵢ(pᵢ−p_{w}) (9)

$$with : {PI}_{i} = \frac{1}{\frac{1}{{k}_{r , i}} ln \frac{{r}_{w}}{{r}_{i}}} Δ {θ}_{j} Δ {x}_{k} \qquad ( 10 )$$

where r_{w} is the radius of the well. This discretization at the well boundaries is similar to the approximation of the fluid flow between two grid cells. However, for discretization of the well boundaries, the discretization coefficient is denoted by the numerical productivity index IP and not by the transmissivity T, and the flow F is replaced by the flow rate qᵢ of the well. This notation is coherent in relation to the commonly used numerical well model, and the skin factor can be integrated in the term of the numerical productivity index IP.

Permeability k_{r,i} varies during the fluid backflow in the zone occupied by the internal filter cake according to the formula given in the previous section. Thus, the transmissivity and the numerical productivity index IP also vary in the simulation during the fluid backflow period.

II-3 Modelling the External Filter Cake

The presence of the external filter cake can be taken into account in the discretization formula via numerical index IP. In the case of the presence of an external filter cake of thickness de and of permeability k_{c}, the well pressure p_{w} corresponds to the pressure on radius r_{w}-dₑ and not on radius r_{w}. The pressure drop is high through the external filter cake which is in the zone located between r_{w}-dₑ and r_{w}. By using again Equation (9) to connect well pressure p_{w}, the pressure of the well grid cells pᵢ and the well flow rate qᵢ, discretization coefficient IP should integrate the effect of the external filter cake as follows (FIG. 5b):

$${PI}_{i} = \frac{1}{\frac{1}{{k}_{r , i}} ln \frac{{r}_{w}}{{r}_{i}} + \frac{1}{{k}_{e}} ln \frac{{r}_{w}}{{r}_{w} - {d}_{e}}} Δ {θ}_{j} Δ {x}_{k} \qquad ( 11 )$$

It is assumed that the external filter cake is eliminated if the pressure difference through the thickness thereof is above a given threshold value. Thus, at the beginning of the fluid backflow, numerical coefficient IP is calculated using Equation (11) which integrates the presence of the external cake if there is one. Once the pressure difference through the filter cake is above the given threshold, numerical productivity index IP is calculated with Equation (10).

Permeability kₑ of the external filter cake could generally be much lower than the permeability in the reservoir or in the zone occupied by the internal filter cake. Thus, in the presence of the external filter cake, numerical coefficient IP is very small.

The simulations can be carried out using a flow simulation tool such as the ATHOS model for example (ATHOS is a numerical modelling model developed by IFP). The discretization scheme used is a conventional 5-point scheme for modelling the diffusivity equation with a cylindrical grid pattern. In the grid cells in the immediate vicinity of the well, a numerical 1P is used to connect the pressure in these grid cells, the bottomhole pressure and the rate of flow towards the well. Since the permeability in the vicinity of the well changes during the clearing period, the transmissivities around the well and the IP also change according to the variation of the permeabilities.

The curves which define the permeability multiplying coefficients as a function of the distance to the well, c₁(r) and c₂(r), are input into the simulator in the form of value charts. The corresponding values in each grid cell are calculated from these curves using a linear interpolation as explained above. The cumulative porous volume of fluid flowing through an interface between two grid cells in radial direction r is used to calculate the multiplying coefficient of transmissivity between these two grid cells at each time considered.

III Numerical Results

We present two examples to illustrate the capacities of the method which has been developed: the first one relates to the clearing of an internal cake without an external cake, and the second one clearing in the presence of an internal cake and of an external cake.

### EXAMPLE 1

### Clearing in the Presence of the Internal Cake Alone

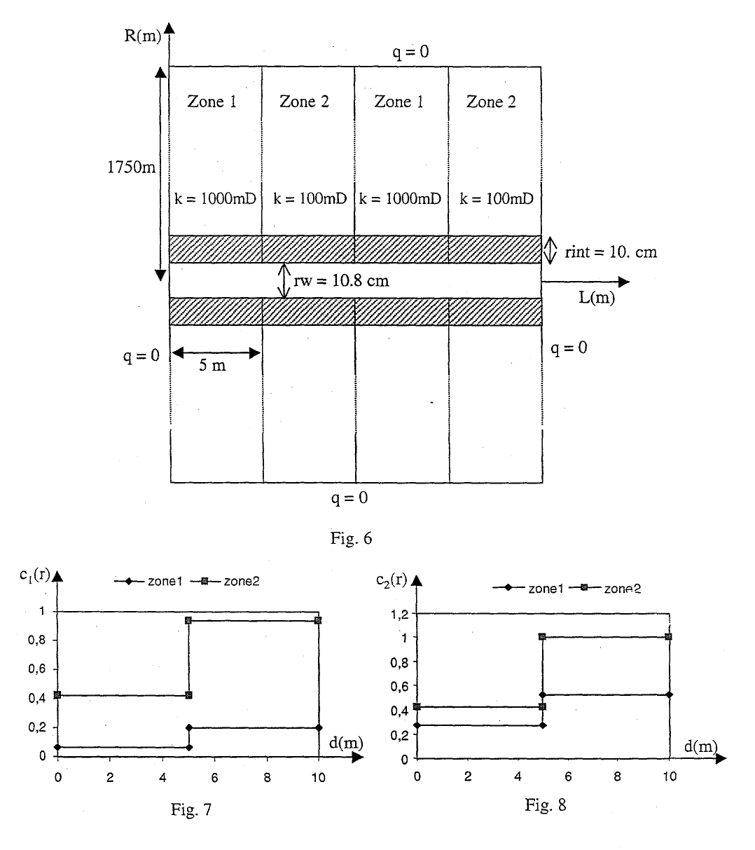

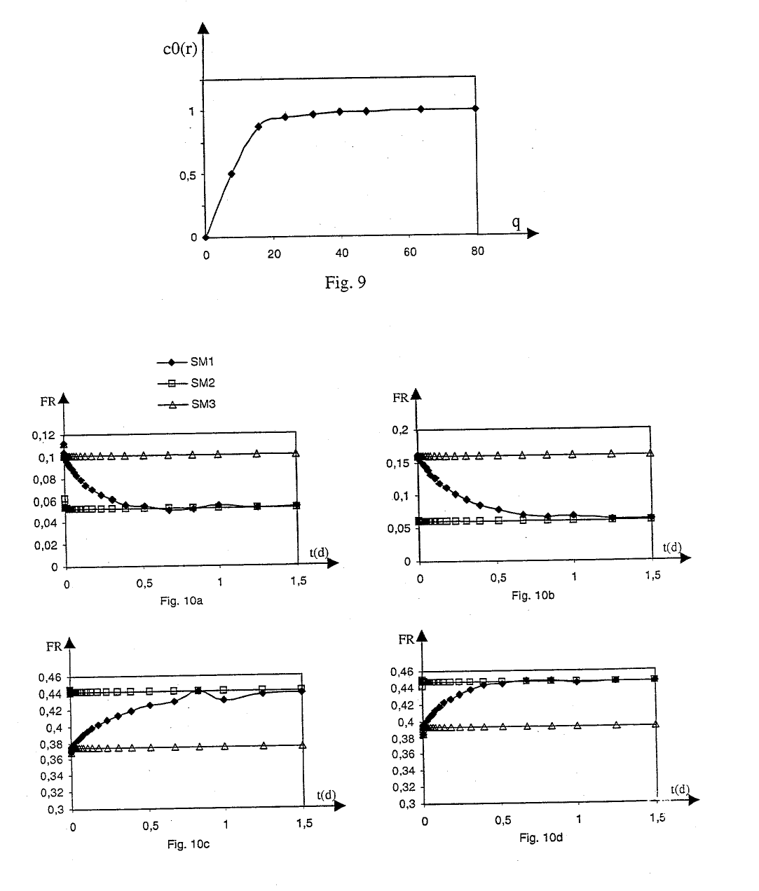

We consider a 20-m long part of a horizontal well running through 4 zones alternately representative of two different heterogeneity types (FIG. 6). The permeabilities k of the corresponding media, initially without damage, are 1000 and 100 mD. The length of each medium crossed is 5 m. The values of the permeability in the grid cells where the internal cake due to the damage has formed are entered manually into the data set. The curves, by zones, of the multiplying coefficient of the damage permeability as a function of the distance to the wall of the well c₁(r) are given in FIG. 7. The restored permeability curves c₂(r) are shown in FIG. 8. These curves are discontinuous because the data supplied by the laboratory measurements only concern some points. The larger the number of points, the better the laboratory curve is represented. The permeability variation during cleaning as a function of the amount of fluid flowing through the porous surface unit, c₀(V), is shown in FIG. 9. In practice, the maximum plateau can be reached with somes cubic meters of fluid per surface unit.

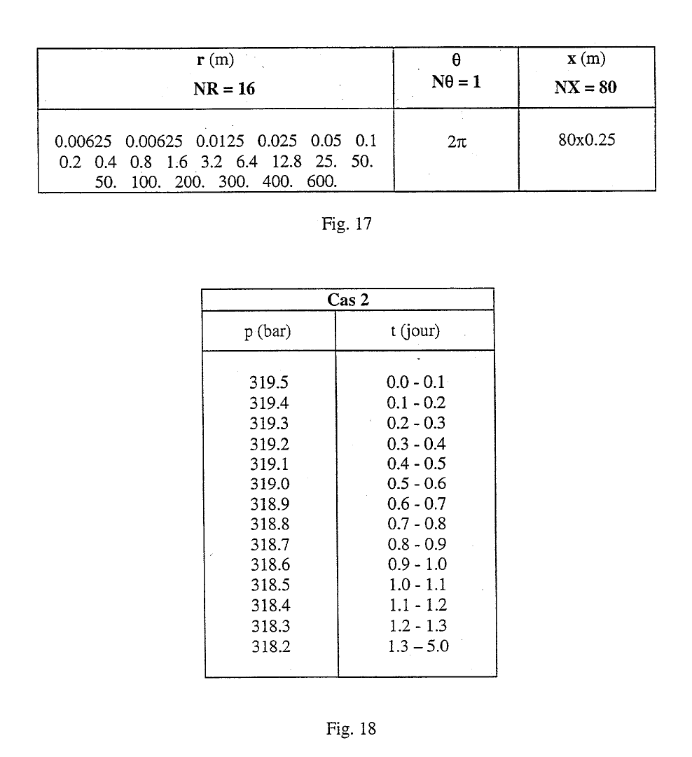

As already mentioned, a cylindrical grid pattern is used for the simulations. The reservoir is very large in the radial direction with a 1750-m outside radius where the boundary condition is a zero flow condition. On the boundaries at the two ends of the well, the condition also is a zero flow condition. The number and the size of the grid cells in directions r and x are given in FIG. 17 (θ=360°). The well is discretized in 80 grid cells along the length thereof. Each constant-permeability zone is thus discretized in 20 0.25-m grid cells. The initial pressure in the reservoir at the depth of the well is substantially 320 bars.

Two simulations were carried out with different conditions applied to the well:

a) A 20 m³/d flow rate is applied in the well for 1.5 day. The flow in the vicinity of the well simulated with the method presented above, by taking account of the permeability variation with time, is denoted by SM1. This simulation is compared with two other simulations using the conventional flow model with unchanged permeabilities, equal on the one hand to the damage permeabilities c₁(r) and, on the other, to the restored permeabilities c₂(r). These two simulations are denoted by SM2 and SM3.

The simulation results are presented for the grid cells 31 and 40 located in the middle and at the boundary of one of the low-permeability zones, and for grid cells 41 and 50 located at the boundary and in the middle of the next more permeable zone. FIG. 10 shows the oil flow rates at the level of these grid cells for the three simulated scenarios: SM1, SM2 and SM3. The simulations with fixed permeabilities, SM2 and SM3, give constant flow rates for each grid cell, which is normal since the boundary in direction r is not reached for the short simulated time (1.5 day). On the other hand, the flow rates vary when the permeability variations in the internal cake during recompletion are modelled. At the time 0, these flow rates are identical to those obtained for the simulations with the permeabilities resulting from well damage. They differ thereafter because the permeabilities increase in the internal cake as a result of cleaning by the formation oil. These flow rates very quickly, after one day, become similar again to those simulated with the restored permeabilities.

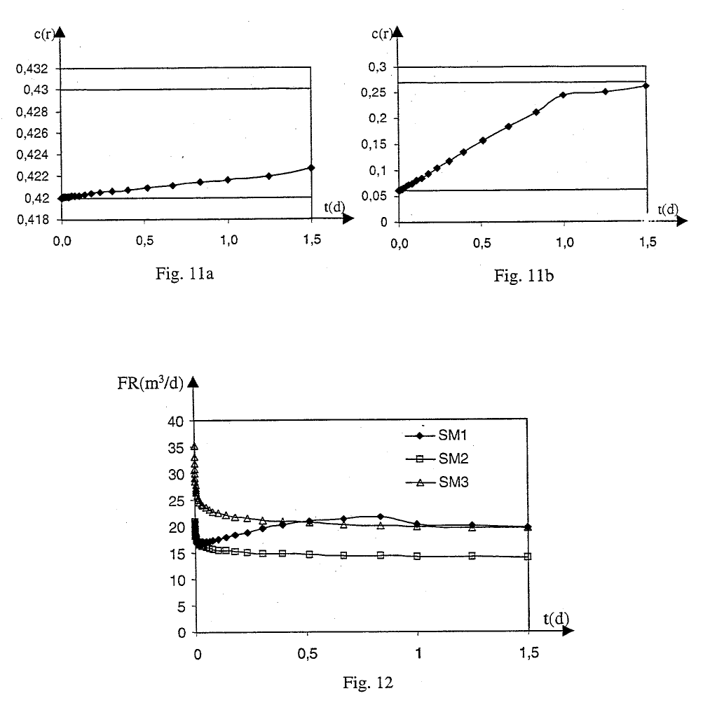

The permeability variations in grid cells 31 and 50 are shown in FIGS. 11a, 11b respectively. These variations correspond to those in the two zones. The permeabilities in the damaged and restored states are also shown. The permeability variation during cleaning lies within these boundary values. After one day, the permeability in the most permeable zone (grid cell 50) is nearly similar to the restored permeability value, and the permeability in the least permeable zone (grid cell 31) does not change much. However, as the variation between the damage permeability and the restored permeability is very low in the low-permeability zone, the simulation results mainly depend on the permeability variation in the most permeable zone. In the results shown in FIG. 10, the flow rates increase in the more permeable zones and they very quickly reach those of simulation SM3. The flow rates in the low-permeability zones decrease because the simulations are carried out with an imposed total bottomhole pressure.

This modelling procedure also allows to obtain the local velocity variation due to cake clearing.

b) A 1-bar pressure difference is applied during 1.5 day.

FIG. 12 shows the variation, as a function of the time t expressed in days, of the corresponding simulated flow rates FR (expressed in m³/d) in the well. In the case of an unchanged permeability (SM2 and SM3), the flow rates decrease with time. On the other hand, modelling of a progressive clearing gives an increasing flow rate up to about one day, which decreases thereafter. The flow rate increase during the initial period is due to the permeability increase in the internal cake during recompletion.

The results in grid cells 31, 40, 41 and 50 are very similar to those of case a. The flow rates obtained when modelling the cake cleaning operation at the time t=0 are equal to those simulated with the damage permeabilities; they vary thereafter and reach the values of the flow rates simulated with the restored permeabilities.

In this example, we observe that well cleaning is rather fast whatever the scenario modelled. In any case, the results of the progressive clearing simulation SM1 are very close, after one day, to those obtained with the restored permeabilities SM3. It is possible to provide details of the short-time results such as, for example, the flow rates along the well, the pressures and the velocities in the vicinity of the well, in order to better know what occurs during clearing. However, the long-time performances of the well, after several days, are nearly identical whatever the configurations studied, knowing that the geomechanical aspects are not taken into account. On this hypothesis, it thus appears that the effects of the internal cake on the well performance are very limited in time and that it is generally sufficient to study this performance by considering the restored permeability, i.e. that of the configuration denoted by SM3.

### EXAMPLE 2

### Presence of a Non-Uniform External Cake Along the Horizontal Well

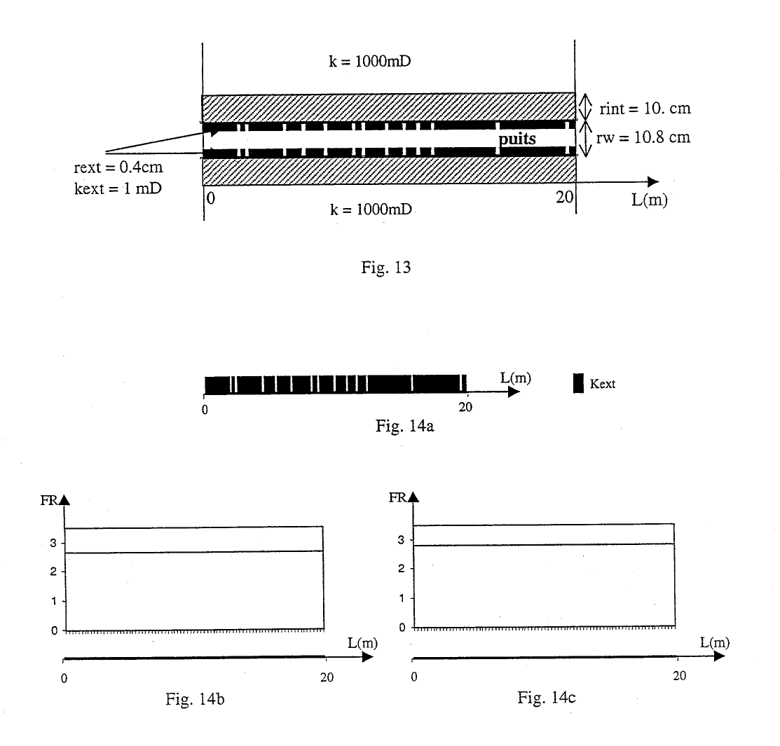

We consider the same well geometry as in the previous example. In this example, the reservoir is homogeneous with a 1000-mD permeability in the porous medium. The external cake has no homogeneous presence along the well. In some places, there is no external cake, and in the places where the external cake is present, it has a 1-mD permeability kₑₓₜ and a 4-mm thickness rₑₓₜ as in the previous example. The distribution of the presence of the external cake is given in FIG. 13. The pressure difference required for removing the external cake is still set at 0.5 bar.

Two types of boundary conditions are used in the simulations. For the first case, a 318.2-bar pressure is applied at the well bottom, i.e. a 1.8-bar pressure difference between the reservoir and the well. For the second case, we apply several consecutive pressure stages to reach a total 1.8-bar pressure drop (Table 2).

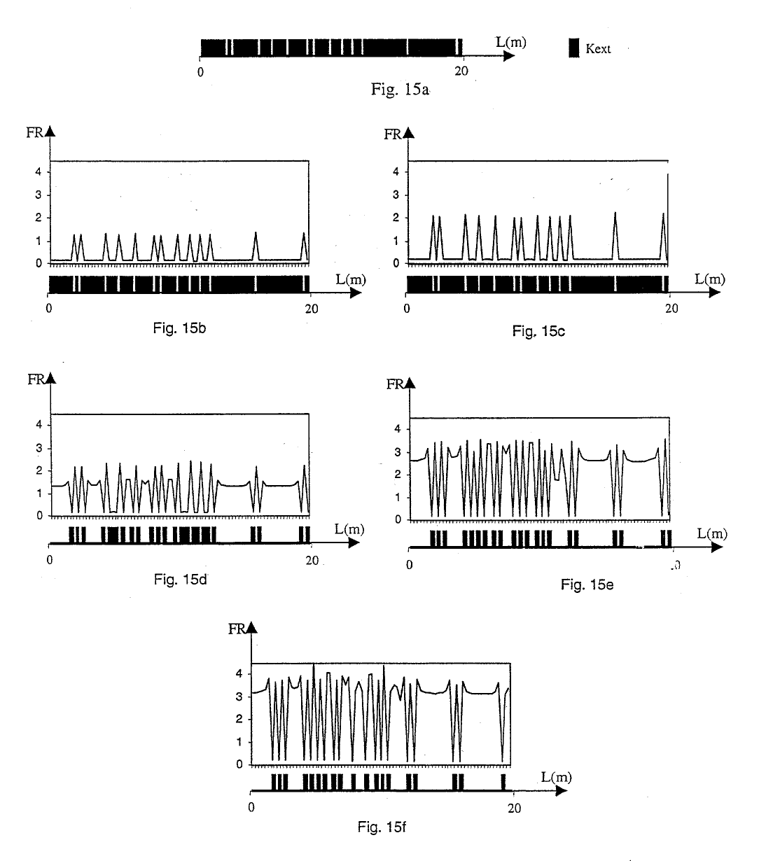

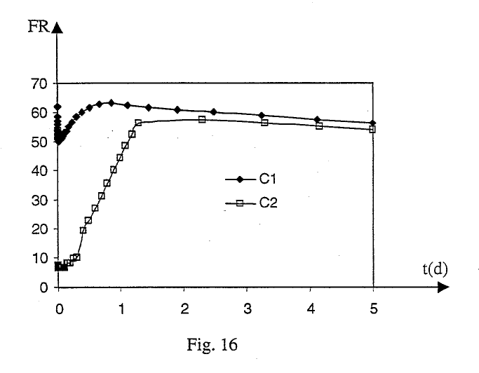

FIGS. 14 and 15 show the distribution of the external cake and the distribution of the flow rate along the well for these two cases at different production times. In the first case, the flow rates are uniform along the well because the external cakes are entirely removed from the beginning. In the second case, the flow rate distribution varies as a function of time because the external cakes are removed in a non-uniform way at different times. Furthermore, there always are external cakes that cannot be removed after 5 days. FIG. 16 shows the well production for these two cases. In the first case, the well production is higher because all the external cakes are removed from the beginning. But the maximum local flow rate along the well still is below 3 m³/m.day. In the second case, the well flow rate is lower but the local flow rate can be very high with a maximum value of 4.5 m³/m.day. The cakes cannot always be removed in certain places. The well performance is thus greatly reduced in this case. This example shows that the clearing procedures can influence the well performance even in a homogeneous reservoir.

Although one would be tempted to apply a great pressure difference between the well and the formation, since it is the procedure which allows fastest and most uniform removal of the external cake which limits the well flow rate, it may be dangerous for the integrity of the well to do so if the formation is not consolidated, and sand encroachment is likely to occur and eventually clog the well. It is one of the interests of the present invention to allow to define the best well clearing procedure without causing the aforementioned hazard from the moment that the fluid velocity from which the sand loses its cohesion is known.

1) A method of simulating optimum conditions to be applied in a well drilled through an underground reservoir with any trajectory so as to progressively eliminate, by means of fluids from the reservoir, deposits or cakes formed in at least a peripheral zone of the well as a result of drilling and completion operations, characterized in that it comprises:
acquiring initial data obtained by laboratory measurements of the thickness of the cakes and of the damaged permeability (kd) and restored permeability (kf) values of the zone surrounding the well, as a function of the distance (r) to the wall of the well, according to the initial permeability value (ki) of the formation surrounding the well,
discretizing the damaged zone by means of a 3D cylindrical grid pattern forming blocks of small radial thickness in relation to the diameter of the well, and
solving in this grid pattern the diffusivity equation modelling the flow of fluids through the cakes by taking account of the measured initial data and by modelling the evolution of the permeability as a function of the flow rates (Q) of fluids flowing through the cakes, so as to deduce therefrom the optimum conditions to be applied for producing the well.

2) A method as claimed in claim 1, characterized in that the restoration of the permeability at any point at a distance (r) from the well is modelled by considering that the permeability varies proportionally to the difference between the damaged permeability (kd) and the restored permeability (kf), the proportionality coefficient depending on an empirical law of permeability variation as a function of the quantity (Q) of fluids flowing through the cakes.
